(19) United States
(12) Patent Application Publication
(10) Pub. No.: US 2026/0252792 A1
(43) Pub. Date: Aug. 27, 2026

(54) AUTOMATICALLY CHOOSING RANKING STRATEGY TO FILL LANGUAGE MODEL PROMPTS WITH MOST RELEVANT DATA

(71) Applicant: Microsoft Technology Licensing, LLC, Redmond, WA (US)

(72) Inventors: Kwan Chak Vincent HO, London (GB); Matthias BRAUNHOFER, Munich (DE); Stephen GRELL, Dachau (DE); Royi RONEN, London (GB)

(73) Assignee: Microsoft Technology Licensing, LLC, Redmond, WA (US)

(21) Appl. No.: 19/065,675

(22) Filed: Feb. 27, 2025

(51) Int. Cl. G06F 40/186; G06F 40/40

(52) U.S. Cl. CPC G06F 40/186; G06F 40/40

(57) ABSTRACT

A data processing system implements receiving a first prompt template; comparing features of the first prompt template with features of a plurality of second prompt templates of a prompt template dataset to identify a set of similar prompt templates, associating a set of candidate ranking strategies with the first prompt template; in response to a plurality of requests to hydrate the first prompt template, identify a ranking strategy from the set of candidate ranking strategies to associate with the first prompt template: receiving user feedback received in response to hydrating the first prompt template using the set of candidate ranking strategies; selecting a ranking strategy from among the set of candidate ranking strategies based on the user feedback; and utilizing the ranking strategy selected from among the set of candidate ranking strategies to rank the data in response to subsequent requests to hydrate the first prompt template.

### BACKGROUND

Large language models can be used to execute prompts that can help users with numerous tasks, such as but not limited to preparing for an upcoming meeting, summarizing content from files or a meeting transcript, generating documents based on other content associated with the user, and/or other such tasks that can assist the user performing various tasks. These tasks are implemented by carefully engineering prompts for the language model. Some prompts require hydration to fill in specific data in the prompts before the prompts can be executed by the language model.

### SUMMARY

An example data processing system according to the disclosure includes a processor and a memory storing executable instructions. The instructions when executed cause the processor alone or in combination with other processors to perform operations including receiving a first prompt template comprising a natural language prompt for a large language model that includes a placeholder term configured to be replaced with data when the first prompt template is hydrated to create an executable prompt, the placeholder term being associated with one or more first data sources that include data used to replace the placeholder term; comparing features of the first prompt template with features of a plurality of second prompt templates of a prompt template dataset to identify a set of similar prompt templates from the plurality of second prompt templates that satisfy a similarity threshold, each respective prompt template of the plurality of second prompt templates being associated with a respective ranking strategy for ranking data obtained from one or more second data sources to hydrate the respective prompt template; associating a set of candidate ranking strategies with the first prompt template, the set of candidate ranking strategies including a ranking strategy associated with prompt templates included in the set of similar prompt templates; in response to a plurality of requests to hydrate the first prompt template, identify a ranking strategy from the set of candidate ranking strategies to associate with the first prompt template; receiving user feedback received in response to hydrating the first prompt template using the set of candidate ranking strategies; selecting a ranking strategy from among the set of candidate ranking strategies based on the user feedback; and hydrating the first prompt template based at least in part on the ranking strategy selected from among the set of candidate ranking strategies to rank the data in response to subsequent requests.

An example method implemented in a data processing system includes receiving a first prompt template comprising a natural language prompt for a large language model that includes a placeholder term configured to be replaced with data when the first prompt template is hydrated to create an executable prompt, the placeholder term being associated with one or more first data sources that include data used to replace the placeholder term; comparing features of the first prompt template with features of a plurality of second prompt templates of a prompt template dataset to identify a set of similar prompt templates from the plurality of second prompt templates that satisfy a similarity threshold, each respective prompt template of the plurality of second prompt templates being associated with a respective ranking strategy for ranking data obtained from one or more second data sources to hydrate the respective prompt template; associating a set of candidate ranking strategies with the first prompt template, the set of candidate ranking strategies including a ranking strategy associated with prompt templates included in the set of similar prompt templates; in response to a plurality of requests to hydrate the first prompt template, identify a ranking strategy from the set of candidate ranking strategies to associate with the first prompt template; receiving user feedback received in response to hydrating the first prompt template using the set of candidate ranking strategies; selecting a ranking strategy from among the set of candidate ranking strategies based on the user feedback; and hydrating the first prompt template based at least in part on the ranking strategy selected from among the set of candidate ranking strategies to rank the data in response to subsequent requests.

An example machine-readable medium on which are stored instructions that, when executed, cause a processor of alone or in combination with other processors to perform operations of receiving a first prompt template comprising a natural language prompt for a large language model that includes a placeholder term configured to be replaced with data when the first prompt template is hydrated to create an executable prompt, the placeholder term being associated with one or more first data sources that include data used to replace the placeholder term; comparing features of the first prompt template with features of a plurality of second prompt templates of a prompt template dataset to identify a set of similar prompt templates from the plurality of second prompt templates that satisfy a similarity threshold, each respective prompt template of the plurality of second prompt templates being associated with a respective ranking strategy for ranking data obtained from one or more second data sources to hydrate the respective prompt template; associating a set of candidate ranking strategies with the first prompt template, the set of candidate ranking strategies including a ranking strategy associated with prompt templates included in the set of similar prompt templates; in response to a plurality of requests to hydrate the first prompt template, identify a ranking strategy from the set of candidate ranking strategies to associate with the first prompt template; receiving user feedback received in response to hydrating the first prompt template using the set of candidate ranking strategies; selecting a ranking strategy from among the set of candidate ranking strategies based on the user feedback; and hydrating the first prompt template based at least in part on the ranking strategy selected from among the set of candidate ranking strategies to rank the data in response to subsequent requests.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram of a user interface that includes prompts for a large language model that have been hydrated according to the techniques described herein.

FIG. 1B is a diagram showing example prompt templates and a corresponding hydrated version of the prompts generated using the techniques described herein.

FIG. 2 is a diagram showing an example of an unmapped prompt template and a prompt template dataset.

FIG. 3 is a diagram showing an example process for identifying candidate ranking strategies for an unmapped prompt template.

FIG. 4 is a diagram showing an example process for selecting candidate ranking strategies for an unmapped prompt template based on user feedback, hydrating the prompt template, and ranking the candidate ranking strategies based on user feedback.

FIG. 5A is a diagram of an example computing environment in which the techniques for hydrating prompts for a large language model disclosed herein are implemented.

FIG. 5B is a diagram of an example implementation of the prompt mapping unit shown in FIG. 5A.

FIG. 5C is a diagram of an example implementation of the prompt hydration unit shown in FIG. 5A.

FIG. 5D is a diagram of an example implementation of the prompt feedback unit shown in FIG. 5A.

FIG. 6A is a diagram showing an example user interface of an application presenting hydrated prompts that includes controls for providing feedback.

FIG. 6B is a diagram showing the example user interface shown in FIG. 6B in which the results of hydrating a selected prompt are presented to the user in a results pane that includes controls for providing feedback.

FIG. 6C is a diagram showing the example user interface shown in FIG. 6B in which the results of hydrating a selected prompt are presented to the user in a results pane that includes a chat interface for providing feedback.

FIG. 6D is a diagram showing an example user interface that enables an authorized user to create a new prompt template.

FIG. 7 is a flow chart of an example process for hydrating prompts for a large language model according to the techniques disclosed herein.

FIG. 8 is a block diagram showing an example software architecture, various portions of which may be used in conjunction with various hardware architectures herein described, which may implement any of the described features.

FIG. 9 is a block diagram showing components of an example machine configured to read instructions from a machine-readable medium and perform any of the features described herein.

### DETAILED DESCRIPTION

Systems and methods for hydrating prompts for a large language model are provided. These techniques provide a prompt hydration framework that provides a technical solution to the problem of automatically generating prompts for a large language model that are relevant to a particular user. The prompts are generated using prompt templates from a prompt template dataset. A prompt template includes instructions for a large language model to generate specific content. The prompt template also includes one or more placeholder terms. Hydrating the prompt, as used herein, refers to replacing the one or more placeholder terms with data that is relevant to the context of the prompt. This data can be selected to be relevant a user for which the hydrated prompt is generated in instances in which the prompt includes user-specific data. A technical benefit of this approach is that the hydrated prompt is more likely to be relevant to the user than preconstructed prompt, and thus, is more likely to provide the user with relevant information when executed by the large language model. Consequently, the computational, energy, and water costs associated with prompt hydration framework can be significantly reduced because the prompts are tailored to be relevant to the user so that the user is less likely to submit subsequent prompts to the language model to generate different content and/or revise the content generated by the language model.

The placeholder terms are replaced with data from one or more data sources associated with each of the placeholder terms. For instance, the placeholder term “person” may be associated with emails, messages, meeting transcripts, document author information, and/or other data sources that are likely to refer people that may be relevant to the user for whom the prompt template is being hydrated. Multiple types of data sources may be associated with each of the placeholder terms. The prompt hydration framework substitutes a name of person included in the data obtained from the one or more data sources. The specific data that is selected to hydrate the prompt is determined using a ranking strategy associated with the prompt template.

Determining which data is most relevant to a prompt is a challenging and error prone process. The prompt hydration framework addresses this technical problem by associating each prompt template with a ranking strategy that is selected from among a set of defined predetermined ranking strategies. The prompt hydration framework applies the ranking strategy to the rank the data obtained from the one or more data sources and selects the highest ranked data to hydrate the prompt template. The highest ranked data is then used to replace the one or more placeholder terms when hydrating the prompt template. Numerous strategies exist for ranking data, and selecting the most appropriate ranking strategy for a particular prompt template depends on the context of how the data is used to hydrate the prompt template. A particular strategy that works well for one type of prompt template may not be appropriate for ranking the data used to hydrate a different type of prompt template. The prompt hydration framework maintains a prompt template dataset that includes a set of prompts that have been mapped to a ranking strategy used to rank the data used to populate the prompts. The prompt hydration framework utilizes the relationship between the prompts and the ranking strategies of the prompt template dataset to automatically identify candidate ranking strategies for new prompt templates that are being added to the prompt template dataset.

The prompt hydration framework identifies a set of candidate ranking strategies by performing a similarity analysis on the new unmapped prompt and the existing mapped prompts included in the prompt template dataset to identify existing mapped prompts that are semantically similar to the new unmapped prompt. The similarity analysis is performed using metadata associated with the new unmapped prompt and metadata associated with the mapped prompts included in the prompt template dataset. The ranking strategies mapped to the identified mapped prompts are then associated with the new unmapped prompt as candidate ranking strategies. The prompt hydration framework tests each of the candidate ranking strategies when hydrating the prompt, selects the best performing ranking strategy from among the candidate ranking strategies based on user feedback and maps the new unmapped prompt to that ranking strategy in the prompt template dataset. The prompt hydration framework then utilizes that ranking strategy for ranking the data that is used to subsequently hydrate that prompt template to generate a hydrate prompt to present to a user. A technical benefit of the approach provided herein is that the prompts are hydrated using a ranking strategy that provides the best performance for that particular prompt. Consequently, the hydrated prompts are more likely to provide useful information to the user, which results in more efficient use of computing resources and energy to generate information that is useful to the user. These and other technical benefits of the techniques disclosed herein will be evident from the discussion of the example implementations that follow.

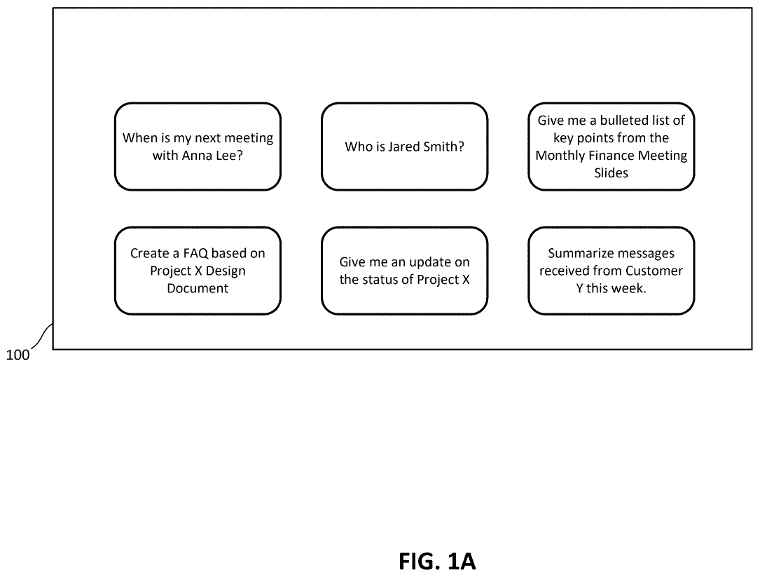

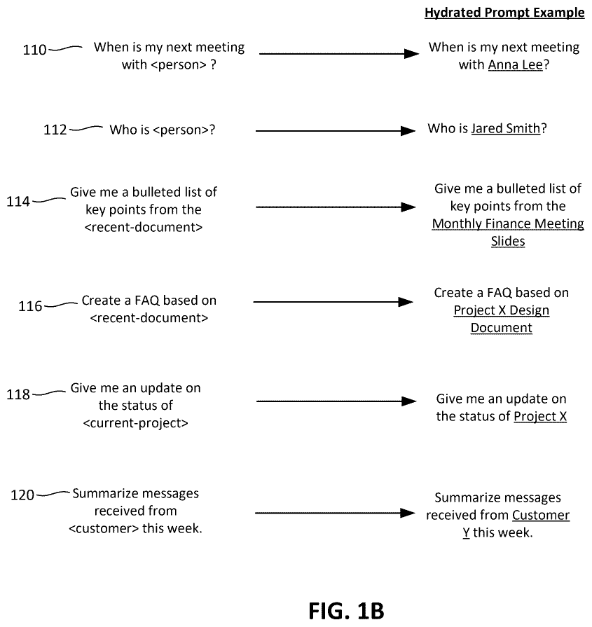

FIG. 1A is a diagram of a user interface 100 of an application that includes prompts for a large language model that have been hydrated according to the techniques described herein. The hydrated prompts are presented on the user interface 100 of the application to help a user with various tasks. The prompts are selected from among a diverse and complex set of prompts in a prompts dataset that can be presented to users of the application. The hydrated prompts are generated from prompt templates that include one or more placeholder terms that are replaced with data relevant to the user. The placeholder terms can be used as a placeholder in the prompt for various entities associated with the user, such as but not limited people, documents, projects, calendar events, and/or other such entities associated with the user. The prompt hydration framework searches one or more data sources for data that can be used to hydrate the prompt, ranks the data using a ranking strategy that is associated with the prompt template, and populates the prompt template with this data. The data sources can include but are not limited to calendar information, meeting transcript information, contact information, email and/or other messages, document content and/or metadata, and/or other data sources. The hydrated prompts can then be presented to the user in various applications, such as on the example user interface 100 shown in FIG. 1A. The user can select one or more of these prompts to be executed and the results of the data presented to the user.

FIG. 1B is a diagram showing example prompt templates for the hydrated prompts shown in FIG. 1A and a corresponding hydrated version of the prompts generated using the techniques described herein. FIG. 1B shows example prompt templates 110, 112, 114, 116, 118, and 120, which represent the hydrated prompts shown on the user interface 100 shown in FIG. 1A. The prompt templates can be used to implement prompts that have different contexts, and thus, the data used to hydrate the prompt template is selected using different ranking strategies. For example, the prompt template 110 and the prompt template 112 shown in FIG. 1B are both prompt templates that include a placeholder term that represents a person. However, the context of the prompt template 110 and the context of the prompt template 112 are quite different. The context of the prompt template 110 is that the user for whom the prompt is being hydrated is familiar with the person whose name is populated in the hydrated prompt and the user has met with this person at least once in the past. Therefore, the prompt template 110 is associated with a ranking strategy that ranks the people included in data obtained from the one or more data sources such that the people with whom the user has previously participated in or is scheduled to participate in a meeting are ranked higher than people that the user knows but has not previously participated in or is scheduled to participate in a meeting. The one or more data sources may include calendar data associated with a calendar application, email and/or other messages discussing a meeting between the user and the other person, meeting information from an online meeting platform, and/or other data source that may include information indicative of the user having previously participated in or is scheduled to participate in a meeting with another person. The ranking criteria may also account for a personal and/or professional relationship between the user and the persons when ranking the search results. In contrast, the prompt template 112 is associated with a ranking strategy that ranks the people included in the search result so that people with whom the user may not be familiar or have a personal or professional relationship are ranked higher than people with whom the user is familiar or with whom the user has a personal or professional relationship. This ranking strategy is more likely to hydrate the prompt template with the name of person who is someone that the user is more likely to request that the language model execute the hydrated prompt. For example, a first person that is mentioned in an email or other message and with whom the user does not have a personal or professional relationship would be ranked higher than a second person with whom the user works with regularly.

The prompt template 114 and the prompt template 116 provide additional examples of prompts having very different contexts for which the best ranking strategy to use for selecting search results to hydrate the prompt are also quite different. The prompt template 114 is prompt that provides the user with a bulleted list of key points for a document that is recently associated with the user. In the context of the prompt template 114, the user would likely find the hydrated prompt to be more useful for a document that the user did not create and/or with which the user is unlikely to be familiar with the contents of the document. For instance, the document may have been emailed to the user, otherwise shared with the user, and/or mentioned during a meeting in which the user participated. In contrast, in the context of the prompt template 116, the user may find the hydrated prompt to be more useful for a document that the user is authoring or collaborating with other users to author the document. The prompt can create a Frequently Asked Question (FAQ) document based on the document that the user is authoring or collaborating with other users to author that the user can share with other users who are not familiar with the content of the document being authored. For instance, the user is contributing a design document for a Project X, and the prompt can suggest that the language model automatically generate a FAQ for Project X based on the design document.

The prompt template 118 and the prompt template 120 provide additional examples of prompts having very different contexts for which the best ranking strategy to use for selecting search results to hydrate the prompt are also quite different. The prompt template 118 is a prompt that presents information on the status of a project associated with the user. In contrast, the prompt template 120 is a template that summarizes email and/or other messages that the user received from a particular customer in the past week. The best ranking strategies for ranking the search results used to hydrate these prompts are going to be significantly different. The ranking strategy associated with prompt template 118 will rank information associated with projects that the user is associated with to identify a project that has been recently mentioned in messages to and/or from the user, in an online meeting in which the user was a participant, and/or information from other data sources to identify a project that is likely to be relevant to a user. In contrast, the ranking strategy associated with the prompt template 120 would rank search results for customers that the user has recently interacted with and/or regularly interacts with to determine a relevant search result to use for hydrating the prompt template 120.

The preceding examples provide examples of some of the types of prompts that the prompt hydration framework may hydrate. However, these examples are not intended to be exhaustive and other types of prompt templates and ranking strategies can be utilized in other implementations.

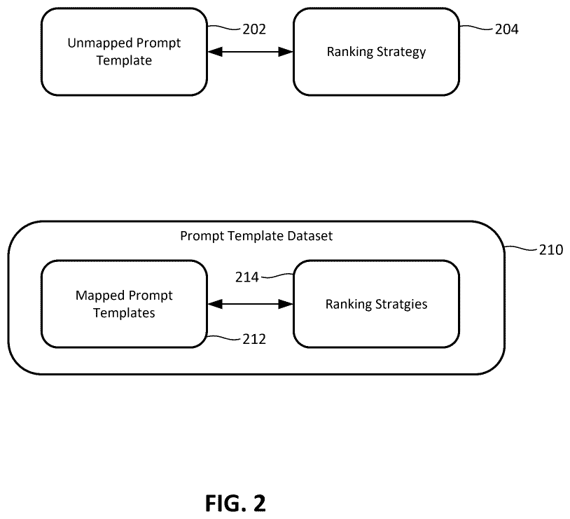

FIG. 2 is a diagram showing an example of an unmapped prompt template 202 and a prompt template dataset 210. The prompt hydration framework enables a user to input a new prompt template, the unmapped prompt template 202, that has not yet been mapped to a ranking strategy 204. The prompt hydration framework maintains a prompt template dataset 210 and utilizes the prompt template dataset 210 to automatically identify a ranking strategy for the unmapped prompt template 202. The prompt template dataset 210 includes mapped prompt templates 212 and ranking strategies 214. The mapped prompt templates 212 are prompt templates that have been associated with a ranking strategy from among the defined ranking strategies included in the ranking strategies 214. The mapped prompt templates 212 have been associated with a respective ranking strategy by a user in some instances and in other instance the prompt hydration framework has automatically identified the ranking strategy associated with the prompt template according to the techniques disclosed herein. In instance in which the prompt hydration framework automatically identifies the best ranking strategy for the unmapped prompt template 202, the prompt hydration framework analyzes the unmapped prompt template 202 and identifies a prompt template of the mapped prompt templates 212 that is most semantically similar to the unmapped prompt template 202 and associates the ranking strategy associated with the most semantically similar prompt template with the unmapped prompt template 202. The prompt hydration framework can then add the unmapped prompt template 202 to the mapped prompt templates 212 of the prompt template dataset 210.

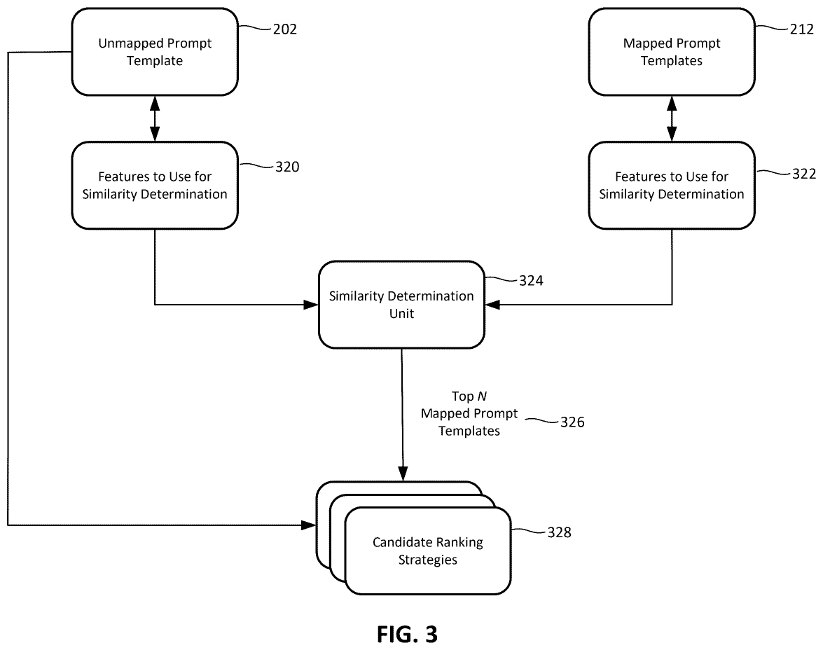

FIG. 3 is a diagram showing an example process for identifying candidate ranking strategies for an unmapped prompt template, such as the unmapped prompt template 202. The unmapped prompt template 202 can be input by an authorized user of the prompt hydration framework via a user interface that enables the user to define input the prompt text and any placeholder terms that are to be substituted for data from one or more data sources when the prompt is hydrated by the prompt hydration framework. The user interface can provide tools that enable the user to select from among a set of predetermined placeholder terms that are associated with one or more predetermined data sources. The user interface can also provide tools that enable the user to define a new placeholder term and to define one or more data sources from which the data to be substituted for the placeholder term can be obtained. The user can also select from among predetermined data sources that have been previously defined.

The prompt hydration framework determines features 320 of the unmapped prompt template to use for similarity computations used to identify a mapped prompt template from among the mapped prompt templates 212 of the prompt template dataset 210. The features 320 can be determined based on the unmapped prompt template 202 using various techniques and/or a combination of techniques. The features 320 can also be determined using metadata associated with the unmapped prompt template 202. The metadata can include various types of information, such as but not limited to a category of prompt associated with the unmapped prompt template 202. For instance, the prompt may be an ask prompt that is a question or instruction given to the large language model, a catch up prompt that instructs the large language model to provide information that focuses on a person's recent activities and/or developments associated with that person, a learning prompt instructs the large language model to generate a summary of a particular topic, or a create prompt that instructs that the large language model to generate new content based on the prompt. These examples are not intended to limit the prompt hydration system to these specific categories of prompt templates. Other implementations can implement other categories of prompt templates in addition to or instead of one or more of these example prompt templates. The prompt category can be provided with the unmapped prompt template 202. As will be discussed in the example which follow, the prompt hydration framework can provide a user interface that enables a user to input a new prompt template, such as the unmapped prompt template 202, and select a category from among a set of predetermined categories associated with the font. In other implementations, the prompt hydration framework constructs a prompt to the large language model instructing the large language model to categorize the unmapped prompt template 202 into one of the categories in the set of predetermined categories. In yet other implementations, the prompt hydration framework utilizes a categorization model that is trained to receive a prompt template, such as the unmapped prompt template 202, as an input and to output a category from among the predetermined set of predetermined categories. The prompt category associated with each of the mapped prompt templates 212 is stored in the prompt template dataset 210. Similarly, the prompt category associated with the unmapped prompt template 202 is stored with the prompt template when the prompt template is added to the mapped prompt templates 212 of the prompt template dataset 210.

The prompt hydration framework can generate the features 320 by analyzing the unmapped prompt template 202, and the prompt category associated with the unmapped prompt template in implementations in which a prompt category is associated with the unmapped prompt template 202. In some implementations, the prompt hydration framework provides the prompt template, and the prompt category when available, as an input to the similarity determination unit 324. The similarity determination unit 324 compares the features 320 of the unmapped prompt template 202 with features 322 of the mapped prompt templates 212 to identify a set of similar prompt templates from the mapped prompt templates 212 that satisfy a similarity threshold. The set of similar prompt templates is referred to as the candidate ranking strategies 328.

In some implementations, the similarity determination unit 324 determines embeddings for the unmapped prompt template 202 and the prompt category in implementations that utilize the prompt category. The embeddings are numerical vectors of values that represent the features of the unmapped prompt template 202 or the unmapped prompt template 202 and the prompt category. The prompt hydration framework can provide the unmapped prompt template 202 or the unmapped prompt template 202 and the prompt category as an input to an embeddings model to obtain the embeddings. The embeddings model can be implemented by the various types of machine learning models, including but not limited to the large language model that is used to determine the prompt category and/or the large language model that will execute the hydrated prompts. Embeddings associated with the mapped prompt templates 212 can be included in the prompt template dataset 210. The prompts for each of the mapped prompt templates 212 are determined using the same embeddings model as the embeddings for the unmapped prompt template 202 to enable the similarity determination unit 324 to compare the features 320 of the unmapped prompt template 202 with the features 322 of the mapped prompt templates 212. The similarity determination unit 324 can then compare the embeddings of the unmapped prompt template 202 with the embeddings of the mapped prompt templates 212 to determine which mapped prompt templates 212 satisfy the similarity threshold. In some implementations, the similarity determination unit 324 determine which mapped prompt templates 212 satisfy the similarity threshold by identifying the top N mapped prompt templates 326 of the mapped prompt templates 212 that are most similar to the unmapped prompt template 202, where N is an integer value that is greater than or equal to one. In some implementations, the value of N is greater than one, and more than one prompt template is selected from among the mapped prompt templates 212. In some implementations, the similarity determination unit 324 applies a clustering algorithm to the embeddings of the unmapped prompt template 202 with the embeddings of the mapped prompt templates 212 to identify the top N mapped prompt templates 326 that are most similar to the unmapped prompt template 202.

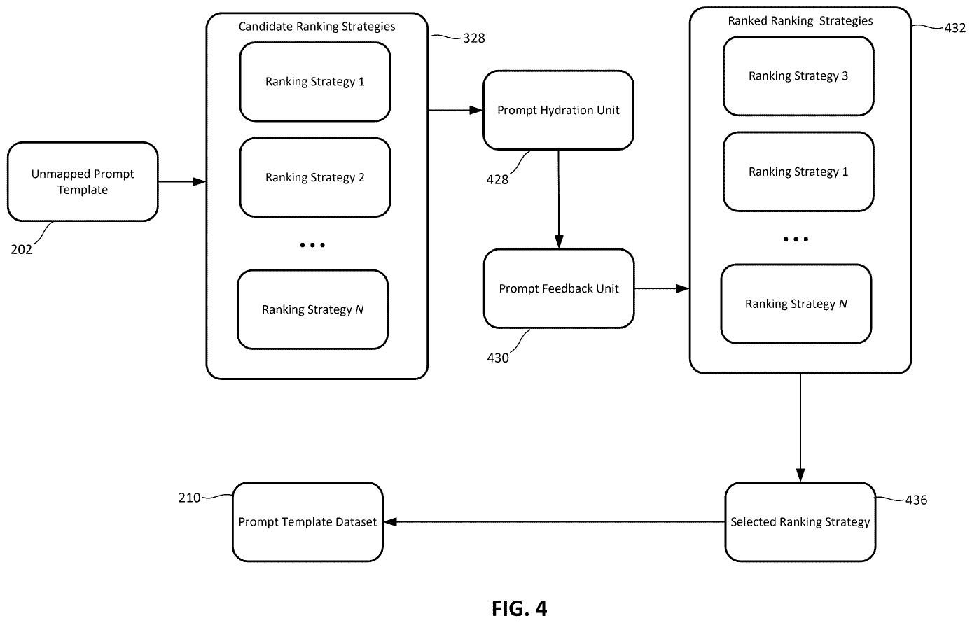

The ranking strategies associated with the top N mapped prompt templates 326 are associated with the unmapped prompt template 202 in the prompt template dataset 210 as candidate ranking strategies 328. The total number of ranking strategies included in the candidate ranking strategies 328 may be less than N in instances in which more than one of the top N mapped prompt templates 326 utilize the same ranking strategy. As discussed in detail with respect to the process shown in FIG. 4, the prompt hydration framework will test each of the candidate ranking strategies 328 and determine which of these strategies performs the best based on user feedback. The ranking strategy from among the candidate ranking strategies 328 that performs the best will be mapped to the unmapped prompt template 202 and the remaining candidate ranking strategies of the candidate ranking strategies 328 no longer associated with the unmapped prompt template 202. The unmapped prompt template 202 is now mapped to the selected ranking strategy.

In some implementations, the similarity determination unit 324 constructs a prompt to a large language model that instructs the large language model to analyze the unmapped prompt template 202 and to select the top N prompt templates from the mapped prompt templates 212. The prompt instructs the language model to select the prompt templates from among the mapped prompt templates 212 that are the most semantically similar to the unmapped prompt template 202. The similarity determination unit 324 can also be configured to construct a prompt to the large language model to analyze the unmapped prompt template 202 to determine a prompt category for the prompt. The similarity determination unit 324 can then use this prompt category to select N prompts from the mapped prompt template 202 that have the same prompt category as the unmapped prompt. In some implementations, the similarity determine unit 324 constructs a prompt to the large language model that instructs the large language model to determine a category for the unmapped prompt template 202 and to select top N most semantically similar prompts within that prompt category from among the mapped prompt templates 212.

FIG. 4 is a diagram showing an example process for selecting candidate ranking strategies 328 for an unmapped prompt template 202 based on user feedback, hydrating the unmapped prompt template 202, ranking the candidate ranking strategies 328 based on user feedback, and selecting a ranking strategy from among the candidate ranking strategies 328 with the unmapped prompt template 202. The process shown in FIG. 4 is utilized by the prompt hydration framework when hydrating the prompt template and is used to determine which ranking strategy among the candidate ranking strategies 328 associated with the unmapped prompt template 202 performs best based on the user feedback from users who have been presented with the hydrated prompt.

Once the unmapped prompt template 202 has been associated with the candidate ranking strategies 328 in the process shown in FIG. 3, the prompt hydration unit 428 can hydrate the unmapped prompt template 202 and provide the hydrated prompt to an application to present the hydrated prompt on a user interface of the application, such as but not limited to the example user interface shown in FIG. 1A. The hydrated prompts are based on the prompt template dataset 210. The hydrated prompts presented on the user interface can include one or more hydrated prompts based on the mapped prompt templates 212 and/or based on unmapped prompt templates that are associated with more than one candidate ranking strategy to be assessed to determine which ranking strategy provides the best performance for the unmapped prompt templates. The prompt templates to be hydrated by the prompt hydration unit 428 can be selected from among the available prompt templates in the prompt template dataset 210 based on various criteria, including but not limited to the type of application on which the hydrated prompts are to be displayed, past user behavior indicating categories of hydrated prompts that the user has previously selected to be executed by the large language model, how frequently the prompt template has been presented to user, and/or based on user feedback to the hydrated prompts and/or the results of executing the hydrated prompts with the large language model.

Each time that the unmapped prompt template 202 is selected for hydration from among the templates in the prompt template dataset 210, the prompt hydration unit 428 searches for content from one or more prompt data sources. The particular data sources that are searched depends at least in part on the placeholder terms to be substituted with data from the one or more prompt data sources. The prompt hydration unit 428 then selects one of the ranking strategies from among the candidate ranking strategies 328 for ranking the search results used to populate the placeholder terms in the unmapped prompt template 202. The ranking strategy may be selected using a round robin approach in which each of the candidate ranking strategies 328 are selected sequentially for use in hydrating the unmapped prompt template 202. This approach ensures that each of the ranking strategies are utilized approximately equally when hydrating the unmapped prompt template 202, and thus, user feedback can be obtained for each of the ranking strategies. Other approaches, such as but not limited to a random selection or pseudo-random selection process can be utilized in other implementations for selecting which ranking strategy to utilize from among the candidate ranking strategies 328.

The prompt feedback unit 430 implements a feedback loop in which users who are presented with the hydrated prompts can provide feedback on the hydrated prompts and/or the results provided by executing the hydrated prompts. This feedback can be used to determine which of the candidate ranking strategies 328 perceived by the users to provide the best results. The prompt feedback unit 430 can collect various types of positive, negative, and/or neutral feedback from users. The feedback may be provided by users from more than one application that presents the hydrated prompts to users. The user interface presenting the hydrated prompts, such as but not limited to the example user interface 100 can include a control that enables the user to provide express feedback on each of the hydrated prompts that are presented. For instance, the user interface presenting the hydrated prompts include controls that enables the user to provide a thumbs up (positive) or thumbs down (negative) response to the hydrated prompt. The user can also provide feedback in response to the results obtained from the large language model in response to executing the hydrated response. For instance, the user interface presenting the results may include controls for providing express feedback, such as but not limited to the thumbs up/thumbs down controls discussed above. The user interface presenting the result may comprise a chat interface that enables the user to input natural language prompts to the large language model. The user may provide natural language feedback that can be analyzed by the large language model and/or by a response classification model that classifies the response as positive, negative, or neutral. The prompt feedback unit 430 can also determine that no response to a particular hydrated prompt and/or results to that hydrated prompt is a neutral response. The prompt feedback unit 430 may collect feedback for the unmapped prompt template 202 until a predetermined feedback threshold condition is met. For instance, the threshold may be a predetermined amount of time elapsed since the unmapped prompt was first presented as a hydrated prompt to users, a number of times that the unmapped prompt has been presented to users, and/or a number of times that express feedback has been received from users. Other threshold criteria can be used in other implementations.

The prompt feedback unit 430 can associate a numerical value with each positive, negative, and/or neural response which can then be used to rank the candidate ranking strategies 328 to generate the ranked ranking strategies 432. The prompt feedback unit 430 can then choose a selected ranking strategy 436 from among the ranked ranking strategies 432. The prompt feedback unit 430 selects the highest ranking strategy from among the ranked ranking strategies 432 in some implementations. The prompt feedback unit 430 can utilize other threshold conditions for choosing the selected ranking strategy 436 in other implementations.

The prompt hydration framework then associates the selected ranking strategy 436 with the unmapped prompt template 202 in the prompt template dataset 210, thereby updates the prompt template to be one of the mapped prompt templates 212. The prompt hydration framework can also then disassociate the candidate ranking strategies 328 that were not selected from the unmapped prompt template 202. Going forward, the prompt hydration framework will utilize the selected ranking strategy 436 when hydrating the prompt template, which is no longer unmapped.

The prompt feedback unit 430 can also receive feedback for prompt templates included in the mapped prompt templates 212 and determine whether the feedback satisfies a reassessment threshold. The prompt feedback unit 430 can determine whether negative user feedback received for the prompt template satisfies a reassessment threshold. Negative user feedback indicates that the user have not found the hydrated prompt and/or results of executing the hydrated prompt useful. The prompt hydration framework can select an alternate ranking strategy for the prompt template. The prompt feedback unit 430 provides an indication to the prompt mapping unit that the prompt mapping unit should once again execute the process shown in FIG. 3 to select a new set of candidate ranking strategies that does not include the ranking strategy that was previously associated with the prompt template. A technical benefit of this approach is that the prompt hydration framework can automatically map a prompt template to a different ranking strategy that may provide better results in response to negative user feedback excluding a threshold value.

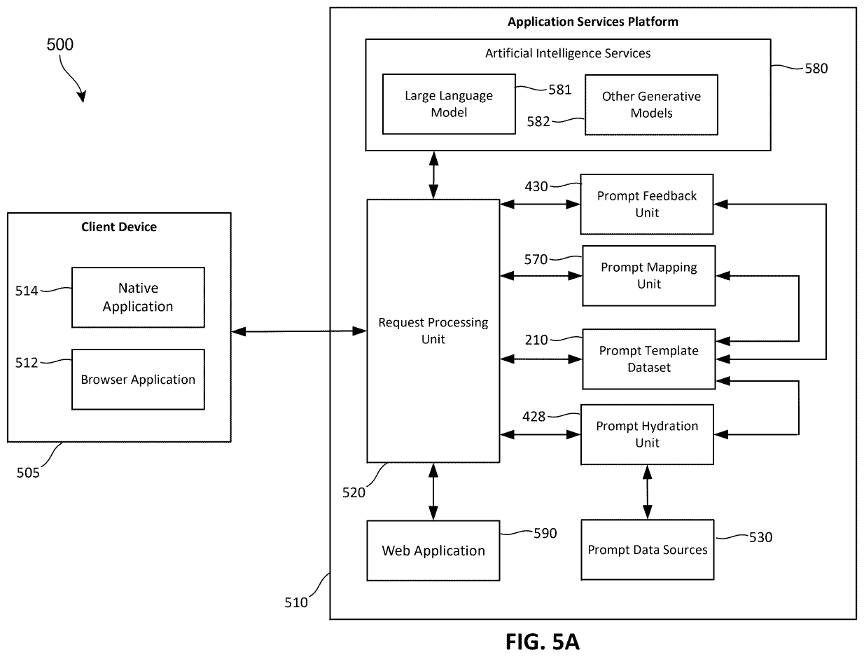

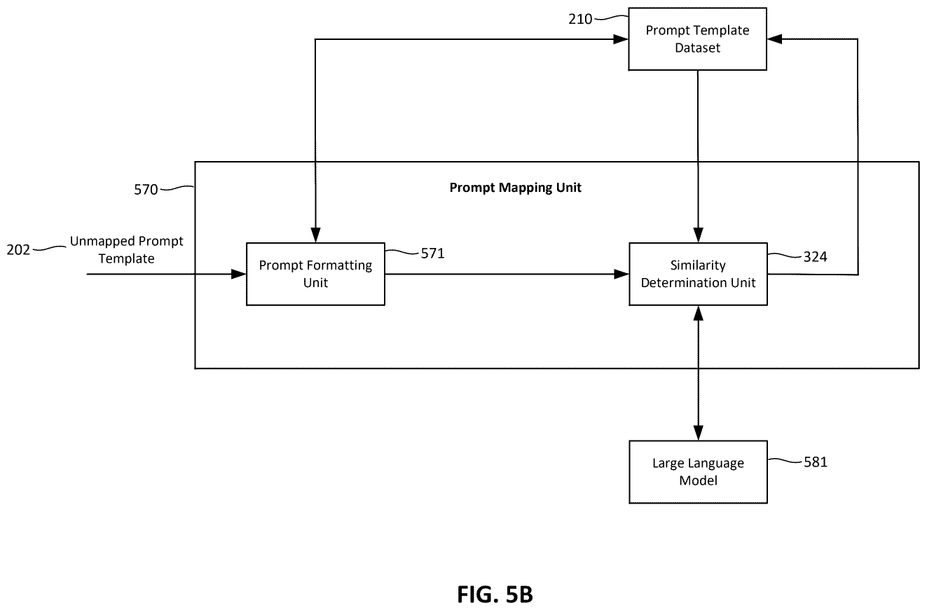

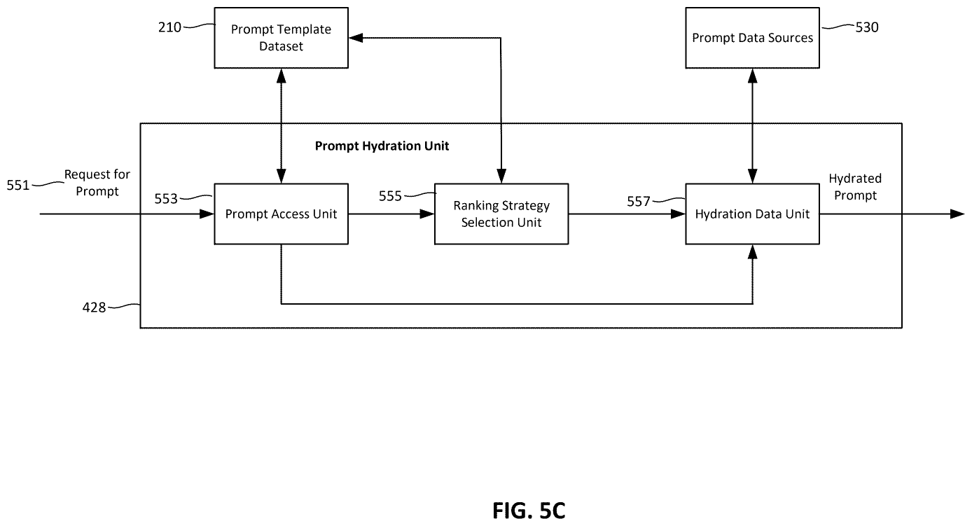

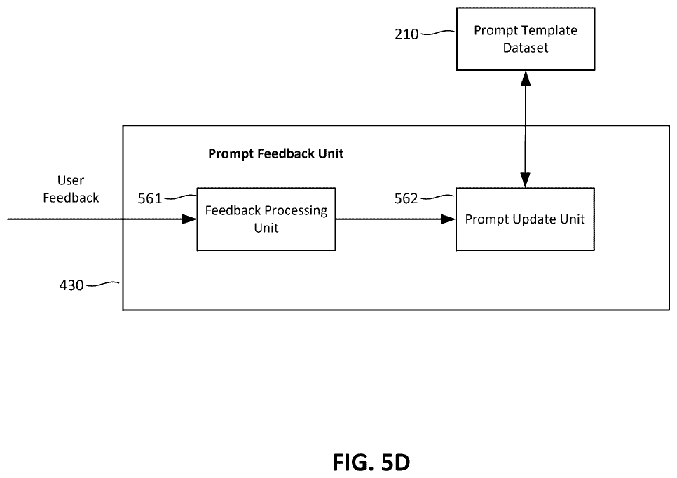

FIG. 5A is a diagram of an example computing environment 500 in which the techniques for hydrating prompts for a large language model disclosed herein are implemented. The example computing environment 500 includes a client device 505 and an application services platform 510. The application services platform 510 provides one or more cloud-based applications and/or provides services to support one or more web-enabled native applications on the client device 505. These applications may include but are not limited to design applications, communications platforms, visualization tools, and collaboration tools for collaboratively creating visual representations of information, and other applications for consuming and/or creating electronic content. The client device 505 and the application services platform 510 communicate with each other over a network (not shown). The network may be a combination of one or more public and/or private networks and may be implemented at least in part by the Internet.

The application services platform 510 implements a prompt hydration system that hydrates prompts for a language model according to the techniques provided herein. The application services platform 510 stores the prompt template dataset 210 in a persistent memory of the application services platform 510. As discussed in the preceding examples, the prompt template dataset 210 includes the mapped prompt templates 212 that have been mapped to one of the ranking strategies 214 supported by the prompt hydration framework. The prompt template dataset 210 can also include one or more unmapped prompt templates, such as the unmapped prompt template 202 discussed in the preceding examples, which have not yet been mapped to a best ranking strategy from among the ranking strategies 214 for ranking the data that is used to hydrate the prompt template. The one or more unmapped prompt templates can be associated with a set of candidate ranking strategies that are being evaluated based on user feedback to determine which is the best ranking strategy for that prompt template.

The prompt mapping unit 570 performs the process shown in FIG. 3 for identifying candidate ranking strategies 328 for an unmapped prompt template, such as the unmapped prompt template 202. The candidate ranking strategies 328 identified by the prompt mapping unit 570 are utilized by the prompt hydration unit 428 to rank the data from the one or more prompt data sources 530 to determine which data should be used to replace the placeholder terms in the prompt template. The prompt hydration unit 428 implements at least a portion of the process shown in FIG. 4 in which the unmapped prompt template 202 selects a candidate ranking strategy from among the candidate ranking strategies 328 and hydrates the prompt template. The prompt feedback unit 430 analyzes user feedback in response to the hydrated prompt as discussed with respect to the process shown in FIG. 3.

The request processing unit 520 receives requests from an application implemented by the native application 514 of the client device 505 and/or the web application 590 of the application services platform 510. The native application 514 and/or the web application 590 provide one or more user interfaces that enables users to view, create, and/or modify electronic content. The native application 514 and/or the web application 590 can also provide one or more user interfaces that present one or more hydrated prompts that the user can click on or otherwise actuate to cause the prompt to be executed by the large language model 581. The request processing unit 520 can receive requests from the native application 514 and/or the web application 590 for prompts to present on a user interface of the native application 514 and/or the web application 590, provide the request to the prompt hydration unit 428, and obtain the hydrated prompts to be presented on the user interface of the native application 514 and/or the web application 590. The request processing unit 520 can also receive requests from the native application 514 and/or the web application 590 with a request to create a new prompt template and provide the request to the prompt mapping unit 570 to associate the new prompt template with a set of candidate ranking strategies. The request processing unit 520 can also receive feedback from the native application 514 and/or the web application 590 and provide the feedback to the prompt feedback unit 430 for processing. The request processing unit 520 also coordinates communication and exchange of data among components of the application services platform 510 as discussed in the examples which follow.

The AI services 580 provide various machine learning models that analyze and/or generate content. The AI services 580 includes a large language model 581. The large language model (LLM) is an artificial neural network characterized by the size of the model. For instance, an LLM may include a billion or even a trillion weights. The large language model 581 can be implemented by a Generative Pre-Trained Transformer (GPT) language model in some implementations. Other types of AI models that are capable of generating content in response to a textual prompt can be utilized in other implementations. The large language model 581 is used by the prompt hydration framework to hydrate the prompt templates in the prompt template dataset 210. The large language model 581 can also be used to generate a textual response to a hydrated prompt.

The AI services 580 can also include other generative models 582. The other generative models can include artificial intelligence models that are capable of generating audio, video, images, various types of documents, and/or other types of content. In some implementations, the large language model 581 can implement the functionality of the other generative models 582. The other generative models can be implemented utilizing various model architectures. Some models may be implemented using a GPT language model architecture, while other models may be implemented using other model architectures.

The client device 505 is a computing device that may be implemented as a portable electronic device, such as a mobile phone, a tablet computer, a laptop computer, a portable digital assistant device, a portable game console, and/or other such devices in some implementations. The client device 505 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 5A includes a single client device, other implementations may include a different number of client devices that utilize services provided by the application services platform 510.

The client device 505 includes a native application 514 and a browser application 512. The native application 514 is a web-enabled native application, in some implementations, that enables users to view, create, and/or modify electronic content. The web-enabled native application utilizes services provided by the application services platform 510 including but not limited to creating, viewing, and/or modifying various types of electronic content. The native application 514 can utilize the application services platform 510 to generate various types of content in response to user prompts, to hydrate one or more prompt templates to provide hydrated prompts to present on a user interface of the native application 514, and to execute hydrated prompts in response to the user clicking on otherwise actuating a control indicating that the hydrated prompt should be executed. In other implementations, the browser application 512 is used for accessing and viewing web-based content provided by the application services platform 510. In such implementations, the application services platform 510 implements one or more web applications, such as the web application 590, that enables users to view, create, and/or modify electronic content. The web application 590 can utilize the application services platform 510 to generate various types of content in response to user prompts, to hydrate one or more prompt templates to provide hydrated prompts to present on a user interface of the web application 590, and to execute hydrated prompts in response to the user clicking on otherwise actuating a control indicating that the hydrated prompt should be executed. The application services platform 510 supports both web-enabled native applications and a web application in some implementations, and the users may choose which approach best suits their needs.

FIG. 5B provides an example implementation of the prompt mapping unit 570 that provides additional details of the functionality of the prompt mapping unit 570 shown in FIG. 5A. The prompt mapping unit 570 includes a prompt formatting unit 571 that receives an unmapped prompt template that has been input by a user, such as the unmapped prompt template 202 shown in the preceding examples. The unmapped prompt template 202 can be input via a user interface of the native application 514 and/or the web application 590.

The prompt formatting unit 571 receives the unmapped prompt template that has been input by the user and analyzes the format of the prompt template. The prompt formatting unit 571 can reject the prompt template if the prompt format is incorrect. For instance, the prompt hydration system can be configured to support specific delimiters to indicate the presence of a placeholder term that will be hydrated, and the prompt formatting unit 571 can detect that one of the delimiters is missing. The prompt formatting unit 571 can also submit the prompt template to a moderation service (not shown) to ensure that the prompt template does not include any potentially objectionable or offensive content or is attempting to cause the large language model 581 or the other generative models 582 to perform prohibited actions. Such prohibited actions can include but are not limited to prompts that would cause the large language model 581 or the other generative models 582 to reveal sensitive information about the structure of the model and/or cause the model to circumvent protections that prevent the model from generating objectionable or offensive content. The prompt formatting unit 571 can also analyze the textual content of the prompt to remove extraneous spaces, carriage returns, and/or other formatting issues with the prompt content that may negatively impact the similarity comparison performed by the similarity determination unit 324. The prompt formatting unit 571 provides the unmapped prompt template to the similarity determination unit 324.

The similarity determination unit 324 performs the comparison of the unmapped prompt template 202 and the mapped prompt templates 212 to identify the top N mapped prompt templates 326 as shown in FIG. 3. The similarity determination unit 324 can determine the features 320 of the unmapped prompt template 202 and the features 322 of the mapped prompt template 212 and compare the features 320 and the feature 322 to determine the top N mapped prompt templates 326. The similarity determination unit 324 determines the candidate ranking strategies 328 to associate with the unmapped prompt template 202 based on the ranking strategies associated with the top N mapped prompt templates 326. The similarity determination unit 324 updates the prompt template dataset 210 to associate the candidate ranking strategies 328 with the unmapped prompt template 202 so that the prompt hydration unit 428 can evaluate the candidate ranking strategies 328 to select the best ranking strategy for the prompt based on user feedback.

Some implementations of the similarity determination unit 324 construct a prompt to a large language model that instructs the large language model to analyze the unmapped prompt template 202 and to select the top N prompt templates from the mapped prompt templates 212. The prompt instructs the language model to select the prompt templates from among the mapped prompt templates 212 that are the most semantically similar to the unmapped prompt template 202. The similarity determination unit 324 can also be configured to construct a prompt to the large language model to analyze the unmapped prompt template 202 to determine a prompt category for the prompt. The similarity determination unit 324 can then use this prompt category to select N prompts from the mapped prompt template 202 that have the same prompt category as the unmapped prompt. Some implementations of the similarity determine unit 324 construct a prompt to the large language model that instructs the large language model to determine a category for the unmapped prompt template 202 and to select top N most semantically similar prompts within that prompt category from among the mapped prompt templates 212.

FIG. 5C provides an example implementation of the prompt hydration unit 428 that provides additional details of the functionality of the prompt mapping unit 570 shown in FIG. 5A. The prompt hydration unit 428 hydrates prompt templates according to the process shown in FIG. 4. The prompt hydration unit 428 receives a request 551 for one or more hydrated prompts from the native application 514 and/or the web application 590. The prompt access unit 553 selects one or more prompt templates from the prompt template dataset 210 based on various criteria, including but not limited to the type of application on which the hydrated prompts are to be displayed, past user behavior indicating categories of hydrated prompts that the user has previously selected to be executed by the large language model, how frequently the prompt template has been presented to user, and/or based on user feedback to the hydrated prompts and/or the results of executing the hydrated prompts with the large language model. Alternatively, the request 551 can be a request to hydrate a specific prompt or prompts to be hydrated in response to the request. Furthermore, the request 551 can be a request to hydrate a particular category of prompt to be hydrated in response to the request. In such implementations, the request 551 can request that one or more prompts in the category of prompt to be hydrated, and the prompt access unit 553 can access one or more prompts associated with this category from the prompt template datastore 210. In response to such requests, the prompt access unit 553 accesses the specific prompts requested.

The prompt access unit 553 determines whether the selected prompt template has been mapped to a particular ranking strategy or whether the prompt template is associated with a set of candidate ranking strategies to be automatically assessed to determine a best ranking strategy for the prompt template. The prompt access unit 553 provides the prompt template and the candidate ranking strategies 328 to the ranking strategy selection unit 555 to select a ranking strategy from among the candidate ranking strategies 328. If the prompt template has been mapped to a ranking strategy, then the ranking strategy mapped to the prompt template is provided to the hydration data unit 557. The prompt access unit bypasses the ranking strategy selection unit 555 in this situation, because the ranking strategy selection unit 555 does not need to select a ranking strategy from among the candidate ranking strategies 328.

The ranking strategy selection unit 555 selects one of the ranking strategies from among the candidate ranking strategies 328 for ranking the search results used to populate the placeholder terms in the prompt template selected by the prompt access unit 553. The ranking strategy may be selected using a round robin approach in which each of the candidate ranking strategies 328 are selected sequentially for use in hydrating the unmapped prompt template 202. This approach ensures that each of the ranking strategies are utilized approximately equally when hydrating the unmapped prompt template 202, and thus, user feedback can be obtained for each of the ranking strategies. The ranking strategy selection unit 555 can implement other approaches, such as but not limited to a random selection or pseudo-random selection process for selecting which ranking strategy to utilize from among the candidate ranking strategies 328. The ranking strategy selection unit 555 updates the prompt template dataset 210 to increment a counter associated with the selected prompt and the selected prompt strategy to indicate that the ranking strategy has been utilized when hydrating a prompt. The counter can be used by the prompt hydration framework to determine which candidate ranking strategies associated with the selected prompt have been used to hydrate the selected prompt and how many times each ranking strategy has been utilized. The prompt feedback unit 430 can also utilize these counters as discussed in the examples which follow. The ranking strategy selection unit 555 then provides the selected prompt and the selected ranking strategy to the hydration data unit 557.

The hydration data unit 557 obtains data to hydrate the prompt template from the one or more prompt data sources 530 and ranks the data obtained from the one or more prompt data sources 530. The hydration data unit 557 constructs search query or queries for obtaining data from the one or more data sources. The data sources may store data in different formats and provide different interfaces that provide different search capabilities. Therefore, the hydration data unit 557 may need to construct multiple queries to obtain the data that may be used to hydrate the prompt template.

The hydration data unit 557 analyzes the prompt to identify the placeholder terms included therein. Referring back to the example prompt template 110 shown in FIG. 1B, the example prompt template includes a placeholder term “<person>” which is denoted by angle brackets. Other types of indicators can be used to denote the placeholder terms other implementations. The hydration data unit 557 then determines which data sources are associated with the placeholder term. The prompt hydration framework maintains a mapping of placeholder terms and the respective data sources to be searched when the placeholder term is included in the prompt template. An administrator or other authorized user of the prompt hydration framework can define this mapping. Additional placeholder terms and/or data sources can be added to the mapping as they become available. The hydration data unit 557 obtains the data from the one or more data sources, combines the data if received from multiple data sources, and ranks the search results based on the selected ranking strategy received from the prompt access unit 553 or the ranking strategy selection unit 555. The hydration data unit 557 can convert the data received from the one or more prompt data sources 530 into a standard format that facilitates applying the ranking strategy to the data obtained from these data sources. The hydration data unit 557 then selects a highest ranked search result for the placeholder term and substitutes the text of the search result for the text of the placeholder term to generate the hydrated prompt. The hydrated prompt is then output by the prompt hydration unit 428 and provided to the native application 514 or the web application 590 that requested the hydrated prompt via the request processing unit 520.

FIG. 5D provides an example implementation of the prompt feedback unit 430 that provides additional details of the functionality of the prompt feedback unit 430 shown in the preceding figures. The prompt feedback unit 430 implements a feedback loop in which users who are presented with the hydrated prompts can provide feedback on the hydrated prompts and/or the results provided by executing the hydrated prompts. The feedback includes an indication of the hydrated prompt and the candidate ranking strategy that was used to rank the search results used to hydrate the prompt. As discussed in the preceding examples, the prompt feedback unit 430 can collect various types of positive, negative, and/or neutral feedback from users, and the feedback may be provided by users from more than one application that presents the hydrated prompts to users. The feedback processing unit 561 receives the feedback and converts the feedback to a standard format that is used by the prompt update unit 562.

The prompt update unit 562 updates the prompt template dataset 210 can increment a counter associated with each of the candidate ranking strategies 328. Positive, negative, and neutral feedback can each be associated with a predetermined value that is used to increment the counter. For instance, the prompt update unit 562 may increment the counter by +2 in response to positive user feedback, by +1 for neutral feedback, and −2 for negative user feedback. Other implementations may utilize different values for incrementing the counter associated with each candidate ranking strategy that associates different weights with the positive, neutral, and negative responses.

The prompt feedback unit 430 may collect feedback for the candidate ranking strategies 328 associated with the unmapped prompt template until a predetermined threshold condition is met. For instance, the threshold may be a predetermined amount of time elapsed since the unmapped prompt was first presented as a hydrated prompt to users, a number of times that the unmapped prompt has been presented to users, and/or a number of times that express feedback has been received from users. Other threshold criteria can be used in other implementations. The prompt feedback unit 430 can then associate the prompt template with the highest ranked candidate ranking strategy associated with the prompt template in response to the threshold being satisfied. The prompt template is then included in the mapped prompt templates 212 of the prompt template dataset 210, and the candidate ranking strategies that were not selected can be discarded or disassociated with the prompt template. The prompt hydration unit 428 then utilizes the ranking strategy that has been associated with the prompt template when subsequently hydrating the prompt template.

The prompt feedback unit 430 can also be used to collect feedback for a prompt template that has been mapped to a ranking strategy and determine whether the feedback satisfies a reassessment threshold. The prompt feedback unit 430 can determine whether negative user feedback received for the prompt template satisfies a reassessment threshold. Negative user feedback indicates that the user have not found the hydrated prompt and/or results of executing the hydrated prompt useful. The prompt hydration framework can select an alternate ranking strategy for the prompt template. The prompt feedback unit 430 provides an indication to the prompt mapping unit that the prompt mapping unit should once again execute the process shown in FIG. 3 to select a new set of candidate ranking strategies that does not include the ranking strategy that was previously associated with the prompt template. A technical benefit of this approach is that the prompt hydration framework can automatically map a prompt template to a different ranking strategy that may provide better results in response to negative user feedback excluding a threshold value.

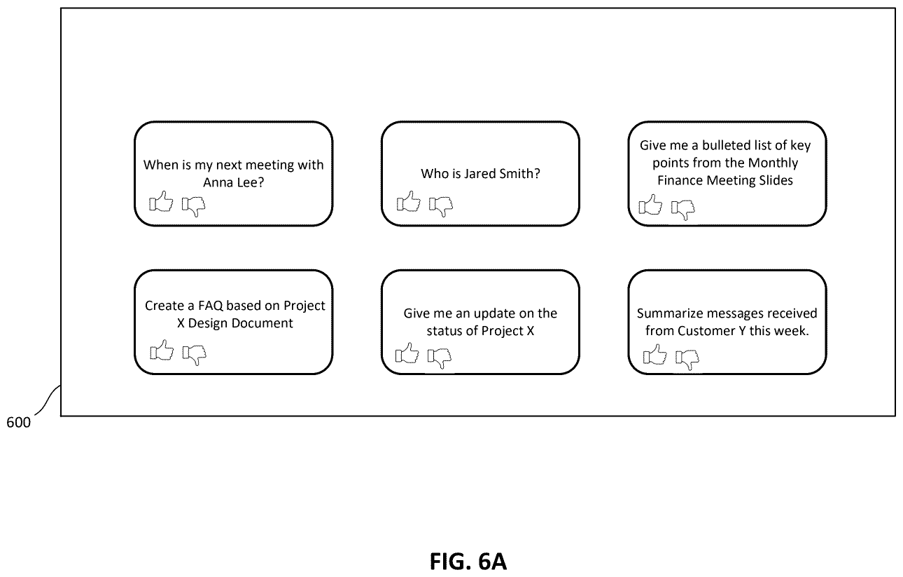

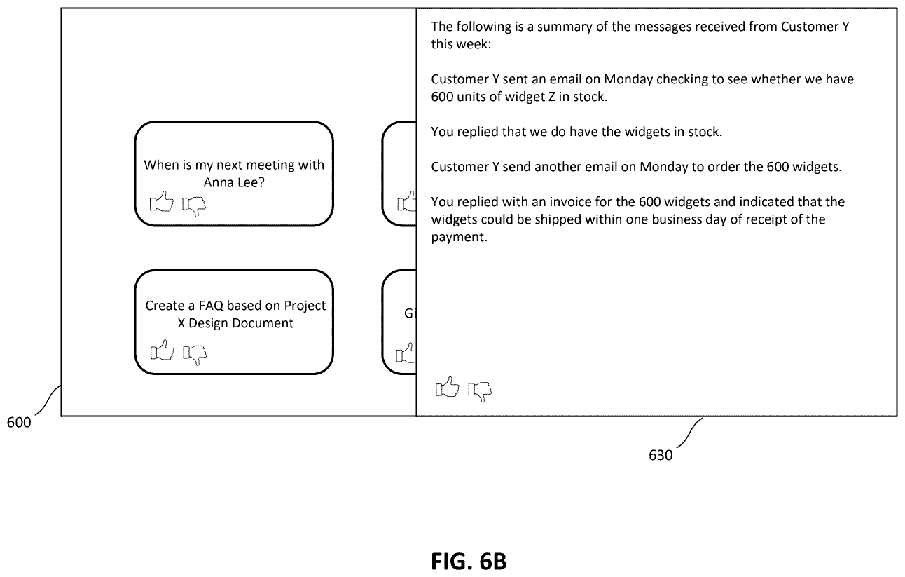

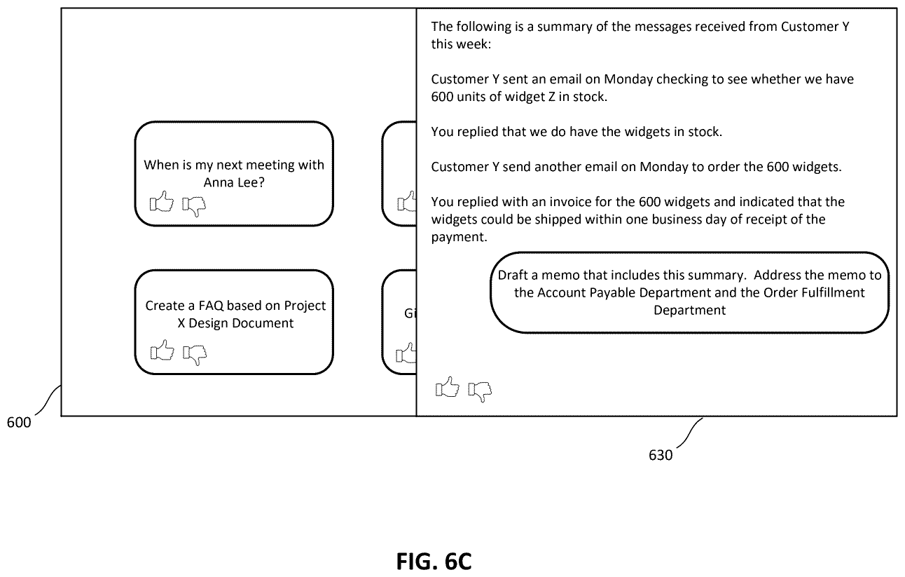

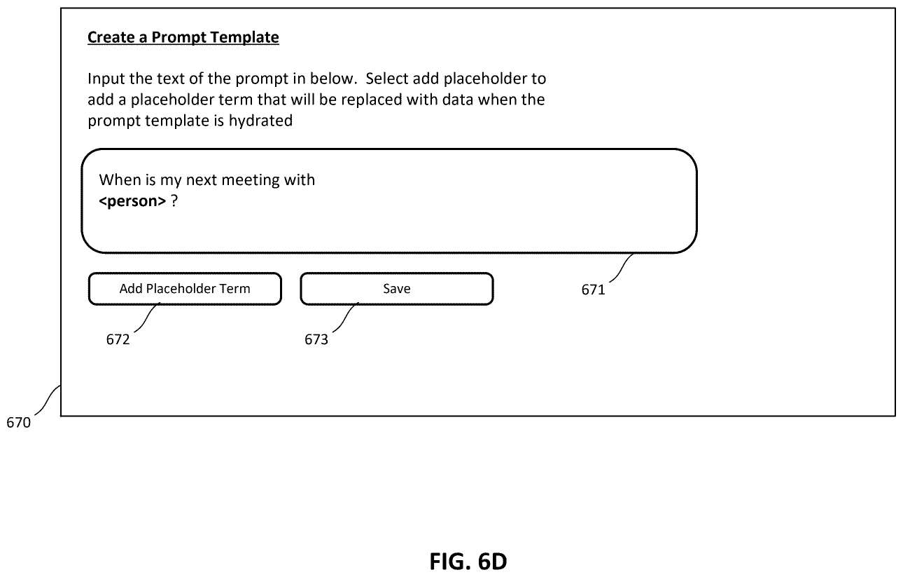

FIG. 6A is a diagram showing an example user interface 600 of an application presenting hydrated prompts that includes controls for providing feedback. The user interface 600 may be implemented by a native application on the client device 505, such as the native application 514, or by a web application implemented on the application services platform 510, such as the web application 590. In the example shown in FIG. 6A, each of the hydrated prompts is associated with set of controls that enable the user to click on or otherwise the “thumbs up” control to provide positive user feedback and a “thumbs down” control to provide negative user feedback. Activating these controls causes the native application 514 or the web application 590 to send an indication of the feedback to the prompt feedback unit 430 for processing.

FIG. 6B is a diagram showing the example user interface 600 shown in FIG. 6A in which the results of hydrating a selected prompt are presented to the user in a results pane 630 that includes controls for providing feedback that are similar to those associated with the hydrated prompts shown in FIG. 6A. Activating these controls causes the native application 514 or the web application 590 to send an indication of the feedback to the prompt feedback unit 430 for processing. The prompt can include

FIG. 6C is a diagram showing the example user interface 600 in FIG. 6B in which the results of hydrating a selected prompt are presented to the user in a results pane 630 that includes a chat interface for inputting natural language prompts to provide feedback and/or request that the large language model 581 perform some action. The textual prompt can be provided to the prompt feedback unit 430 for processing, and the prompt feedback unit 430 can construct a prompt to the large language model 581 instructing the large language model 581 to analyze the user prompt to determine whether the user prompt is a positive, negative, or neutral response to the results provided by executing the hydrated prompt. Negative user feedback on the results of the prompt can indicate that the ranking strategy associated with the prompt template used to generate the hydrated prompt may not be the best ranking strategy for that prompt template.

FIG. 6D is a diagram showing an example user interface 670 that enables an authorized user to create a new prompt template. The user can input the prompt in the input field 671. The user interface includes a first control 672 which, when clicked on or otherwise activated by the user, enables the user to insert a placeholder term in the claim template. Activating the first control 672 causes the native application 514 or the web application 590 to display a list of predefined placeholder terms which can be added to the prompt template. The placeholder terms are each associated with one or more data sources from which the data used to populate the placeholder term can be obtained. In the example shown in FIG. 6D, the prompt includes a “<person>” placeholder term that is associated with one or more data sources that include information on people that can be used to hydrate the prompt template. The user interface 670 also includes a second control 673 which, when clicked on or activated, causes the native application 514 or the web application 590 to provide the new prompt to the prompt mapping unit 570, and the prompt mapping unit 570 adds the unmapped prompt template to the prompt template dataset 210 and automatically identifies a set of candidate ranking strategies to associate with the new prompt template.

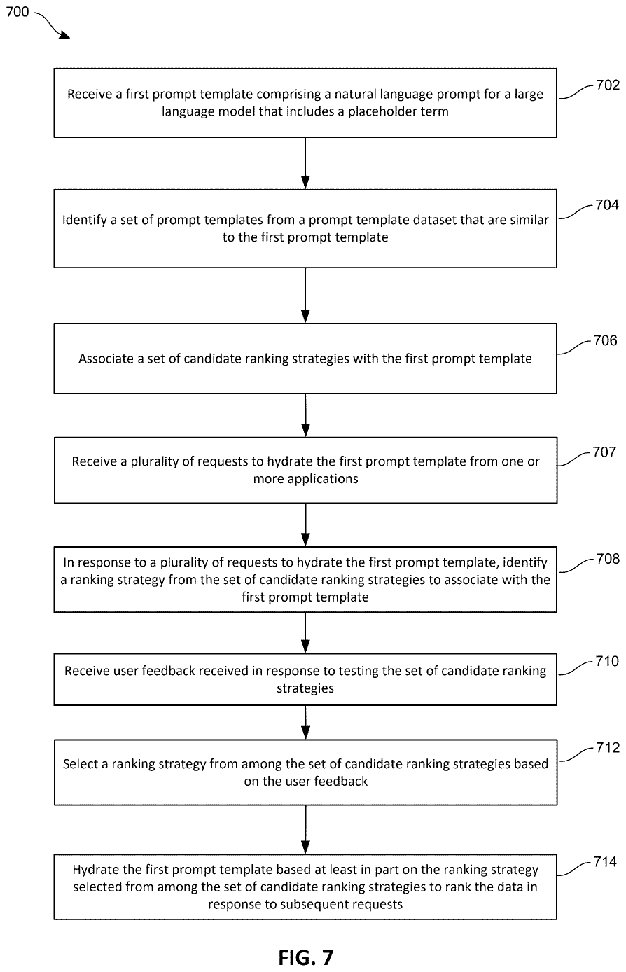

FIG. 7 is a flow chart of an example process 700 for hydrating a prompt for a language model according to the techniques disclosed herein. The process 700 can be implemented by the application services platform 510 and/or the prompt hydration framework discussed in the preceding examples. The prompt hydration framework includes the prompt hydration unit 428, the prompt mapping unit 570, and the prompt feedback unit 430 discussed in the preceding examples.

The process 700 includes an operation 702 of receiving a first prompt template comprising a natural language prompt for a large language model that includes a placeholder term. The prompt template can be hydrated by the prompt hydration framework to create a prompt that is executable by the large language model 581. As discussed in the preceding examples, the placeholder term can be configured to be replaced with data from one or more first data sources. These data sources can be selected from among a set of available data sources that can be used to provide data to hydrate the prompt. The data selected to hydrate the prompt can be associated with a particular user for whom the prompt is being hydrated and/or based on data associated with other users. As discussed in the preceding examples, the prompt mapping unit 570 can receive a new prompt template from the native application 514 or the web application 590.

The process 700 includes an operation 704 of identifying a set of prompt templates from a prompt template dataset that are similar to the first prompt template. As discussed in the preceding examples, the set of similar prompt templates can be identified by constructing a prompt to a large language model to identify the set of similar prompt templates. In other implementations, the similar prompt templates can be identified by comparing features of the first prompt template with features of a plurality of second prompt templates of the prompt template dataset to identify the set of similar prompt templates from the plurality of second prompt templates that satisfy a similarity threshold. Each respective prompt template of the plurality of second prompt templates can be associated with a respective ranking strategy for ranking data obtained from one or more second data sources to hydrate the respective prompt template. The prompt mapping unit 570 performs this comparison as discussed in the preceding examples. The second prompt templates can be implemented by the mapped prompt templates 212 of the prompt template dataset 210.

The process 700 includes an operation 706 of associating a set of candidate ranking strategies with the first prompt template. The set of candidate ranking strategies can include the ranking strategies associated with prompt templates included in the set of similar prompt templates identified in operation 704 or a subset thereof. For instance, the ranking strategies for the top N prompt templates from the mapped prompt templates 212 that were determined to be the closest match to the first prompt template may be selected and the ranking strategies associated with the selected prompt templates associated with the first prompt template as candidate ranking strategies. The prompt mapping unit 570 can identify the candidate ranking strategies 328 according to the process shown in FIG. 3.

The process 700 includes an operation 707 of receiving a plurality of requests to hydrate the first prompt template from one or more applications. As discussed in the preceding examples, one or more native applications, such as the native application 514, and/or one or more web-based applications, such as the web-based application 190 can provide requests to the prompt hydration unit 428 via the request processing unit 520. The requests can be for a specific set of prompts or for a set of prompts selected by the prompt hydration unit 428.

The process 700 includes an operation 708 of in response to a plurality of requests to hydrate the first prompt template, identify a ranking strategy from the set of candidate ranking strategies to associate with the first prompt template. The prompt hydration unit 428 performs the operation 708 as discussed in the preceding examples. This approach enables the prompt hydration framework to test user responses to each of the candidate ranking strategies to determine which candidate ranking strategy provides results that are preferred by the users.

The process 700 includes an operation 710 of receiving user feedback received in response to hydrating the first prompt template using the set of candidate ranking strategies. As discussed in the preceding examples. The prompt feedback unit 430 can receive and process feedback provided by users in response to the hydrated prompts and/or the results output by the large language model 581 in response to executing the hydrated prompts.

The process 700 includes an operation 712 of selecting a ranking strategy from among the set of candidate ranking strategies based on the user feedback. The prompt feedback unit 430 can implement operation 712 as discussed in the preceding examples. The user feedback can include positive user feedback, negative user feedback, and neutral user feedback, and the feedback unit 430 can utilize this feedback to select the best performing ranking strategy from among the candidate ranking strategies associated with the first prompt template.

The process 700 includes an operation 714 of hydrating the first prompt template based at least in part on the ranking strategy selected from among the set of candidate ranking strategies to rank the data in response to subsequent requests. The prompt hydration unit 428 can implement operation 714 to hydrate the prompt using data from the one or more data sources associated with the first prompt template. A technical benefit of this approach is that the ranking strategy that provided the best results in terms of user feedback can be automatically associated with the first prompt template and used to hydrate the prompt template in response subsequent requests without requiring the user who input the select an appropriate ranking strategy or even be aware of the different ranking strategies that may be applied for ranking the data used to hydrate the first prompt template.

The detailed examples of systems, devices, and techniques described in connection with FIGS. 1A-7 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1A-7 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

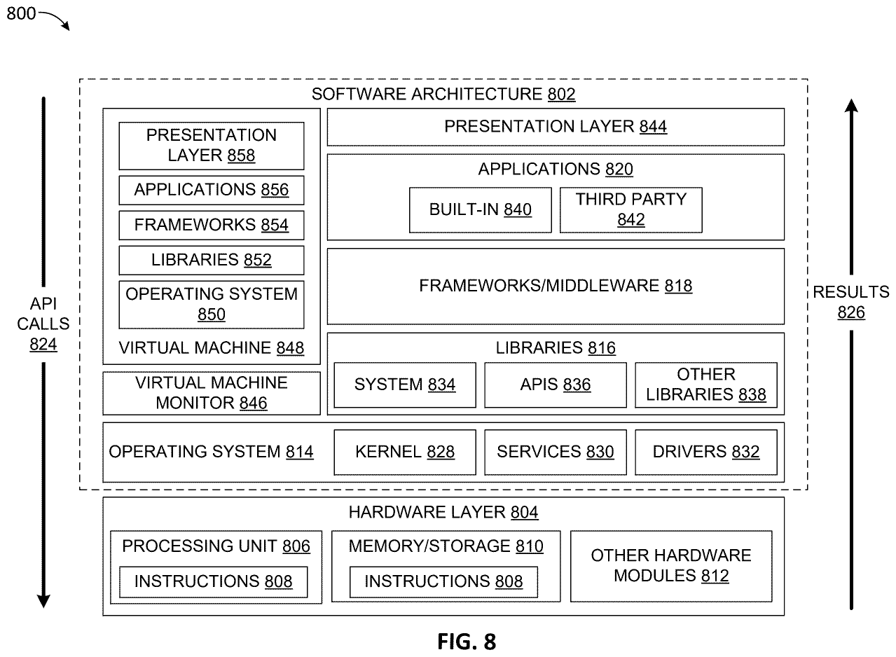

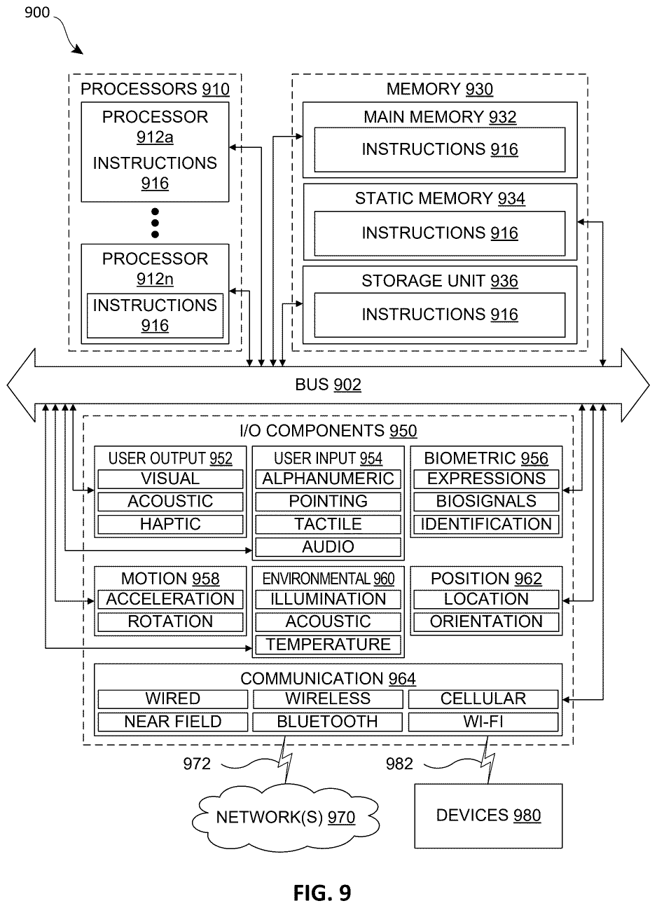

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory/storage, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks/middleware 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks/middleware 818 provide a higher-level common infrastructure that may be used by the applications 820 and/or other software modules. For example, the frameworks/middleware 818 may provide various graphic user interface (GUI) functions, high-level resource management, or high-level location services. The frameworks/middleware 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks/middleware 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory/storage 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multicore processor including cores that may execute instructions contemporaneously. Although FIG. 9 shows multiple processors, the machine 900 may include a single processor with a single core, a single processor with multiple cores (for example, a multicore processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 964, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
receiving a first prompt template comprising a natural language prompt for a large language model that includes a placeholder term configured to be replaced with data when the first prompt template is hydrated to create an executable prompt, the placeholder term being associated with one or more first data sources that include data used to replace the placeholder term;
comparing features of the first prompt template with features of a plurality of second prompt templates of a prompt template dataset to identify a set of similar prompt templates from the plurality of second prompt templates that satisfy a similarity threshold, each respective prompt template of the plurality of second prompt templates being associated with a respective ranking strategy for ranking data obtained from one or more second data sources to hydrate the respective prompt template;
associating a set of candidate ranking strategies with the first prompt template, the set of candidate ranking strategies including a ranking strategy associated with prompt templates included in the set of similar prompt templates;
receiving a plurality of requests to hydrate the first prompt template from one or more applications;
in response to a plurality of requests to hydrate the first prompt template, identifying a ranking strategy from the set of candidate ranking strategies to associate with the first prompt template;
receiving user feedback received in response to hydrating the first prompt template using the set of candidate ranking strategies;
selecting a ranking strategy from among the set of candidate ranking strategies based on the user feedback; and
hydrating the first prompt template based at least in part on the ranking strategy selected from among the set of candidate ranking strategies to rank the data in response to subsequent requests.

2. The data processing system of claim 1, wherein to test the set of candidate ranking strategies the memory further stores executable instructions that, when executed, cause the processor alone or in combination with other processors to perform operations of:
selecting a respective ranking strategy from among the set of candidate ranking strategies in response to a respective request to hydrate the first prompt template;
obtaining data from the one or more first data sources in response to the respective request to hydrate the first prompt template;
ranking the data from the one or more first data sources according to the respective ranking strategy selected from among the set of candidate ranking strategies to generate ranked data;
hydrating the first prompt template by replacing the placeholder term in the first prompt template with data from the ranked data to generate a first hydrated prompt; and
providing the first hydrated prompt to an application to present on user interface of the application.

3. The data processing system of claim 1, wherein to compare features of the first prompt template with features of the plurality of second prompt templates to identify the set of similar prompt templates the memory further stores executable instructions that, when executed, cause the processor alone or in combination with other processors to perform operations of:
analyzing the first prompt template with an embeddings model to generate embeddings that provide a first numerical vector representation of features of the first prompt template;
analyzing the plurality of second prompt templates with the embeddings model to generate embeddings that provide second numerical vector representations of features of the plurality of second prompt templates; and
comparing the first numerical vector representation of the first prompt template with the second numerical vector representations of the plurality of second prompt templates to identify the set of similar prompt templates that satisfy the similarity threshold.

4. The data processing system of claim 3, wherein to compare the first numerical vector representation of the first prompt template with the second numerical vector representations of the plurality of second prompt templates to identify the set of similar prompt templates that satisfy the similarity threshold, the memory further stores executable instructions that, when executed, cause the processor alone or in combination with other processors to perform operations of:
selecting a predetermined number of the plurality of second prompt templates that are most similar to the first prompt template as the set of similar prompt templates.

5. The data processing system of claim 3, wherein the first prompt template is associated with a first prompt category, and wherein the plurality of second prompt templates are each associated with a respective prompt category of a plurality of second prompt categories, and wherein:
analyzing the first prompt template with the embeddings model to generate the embeddings that provide the first numerical vector representation of features of the first prompt template includes providing the first prompt category with the embeddings model as an input to the embeddings model with the first prompt template; and
analyzing the plurality of second prompt templates with the embeddings model to generate the embeddings that provide the second numerical vector representations of features of the plurality of second prompt templates includes providing the plurality of second prompt categories as inputs to the embeddings model with the plurality of second prompt templates.

6. The data processing system of claim 5, wherein to compare features of the first prompt template with features of the plurality of second prompt templates to identify the set of similar prompt templates the memory further stores executable instructions that, when executed, cause the processor alone or in combination with other processors to perform operations of:
constructing a prompt to the large language model instructing the large language model to analyze the first prompt template and to determine the first prompt category of the first prompt template;
providing the prompt and the first prompt template as an input to the large language model; and
obtaining the first prompt category as an output of the large language model.

7. The data processing system of claim 1, wherein to compare features of the first prompt template with features of the plurality of second prompt templates to identify the set of similar prompt templates the memory further stores executable instructions that, when executed, cause the processor alone or in combination with other processors to perform operations of:
constructing a prompt to the large language model instructing the large language model to analyze the first prompt template and the plurality of second prompt templates to identify the set of similar prompt templates;
providing the prompt, the first prompt template, and the plurality of second prompt templates as an input to the large language model; and
obtaining the set of similar prompt templates as an output of the large language model.

8. The data processing system of claim 1, wherein to compare features of the first prompt template with features of the plurality of second prompt templates to identify the set of similar prompt templates the memory further stores executable instructions that, when executed, cause the processor alone or in combination with other processors to perform operations of:
constructing a prompt to the large language model instructing the large language model to analyze the first prompt template and output a prompt category associated with the first prompt template; and
selecting a set of similar prompt templates from the prompt template dataset based on the prompt category determined output by the large language model.

9. The data processing system of claim 1, wherein to compare features of the first prompt template with features of the plurality of second prompt templates to identify the set of similar prompt templates the memory further stores executable instructions that, when executed, cause the processor alone or in combination with other processors to perform operations of:
constructing a prompt to the large language model instructing the large language model to analyze the first prompt template and the plurality of second prompt templates to identify the set of similar prompt templates by analyzing the first prompt template to determine a prompt category associated with the first prompt template and to identify the set of similar prompt templates associated with the prompt category and having a semantic similarity to the first prompt template;
providing the prompt, the first prompt template, and the plurality of second prompt templates as an input to the large language model; and
obtaining the set of similar prompt templates as an output of the large language model.

10. The data processing system of claim 1, wherein to receive the user feedback received in response to hydrating the first prompt template using the set of candidate ranking strategies, the memory further stores executable instructions that, when executed, cause the processor alone or in combination with other processors to perform operations of:
receiving a user feedback indication from an application in which a hydrated version of the first prompt template was presented on a user interface of the application, the user feedback indication providing an indication of positive user feedback or negative user feedback input by a user of the application.

11. The data processing system of claim 1, wherein to receive the user feedback received in response to hydrating the first prompt template using the set of candidate ranking strategies, the memory further stores executable instructions that, when executed, cause the processor alone or in combination with other processors to perform operations of:
receiving a natural language prompt response from an application in which a hydrated version of the first prompt template was presented on a user interface of the application, the natural language prompt response being input in the user interface of the application by a user of the application in response to presenting the hydrated version of the first prompt template on the user interface;
constructing a prompt for the large language model instructing the large language model to analyze the natural language prompt response and output an indication whether natural language prompt response was positive user feedback or negative user feedback;
providing the prompt and the natural language prompt response as an input to the large language model; and
obtaining the indication whether the natural language prompt response was positive user feedback or negative user feedback output by the large language model.

12. The data processing system of claim 1, wherein to receive the user feedback received in response to hydrating the first prompt template using the set of candidate ranking strategies, the memory further stores executable instructions that, when executed, cause the processor alone or in combination with other processors to perform operations of:
determining that a feedback threshold has been satisfied based on the user feedback; and
selecting the ranking strategy from among the set of candidate ranking strategies based on feedback information associated with each of the set of candidate ranking strategies.

13. The data processing system of claim 1, wherein to receive the user feedback received in response to hydrating the first prompt template using the set of candidate ranking strategies, the memory further stores executable instructions that, when executed, cause the processor alone or in combination with other processors to perform operations of:
receiving user feedback on the first prompt template after selecting the ranking strategy from among the set of candidate ranking strategies;
determining that the user feedback has satisfied a reassessment threshold;
associating a set of new candidate ranking strategies with the first prompt template; and
testing the set of new candidate ranking strategies, in response to a plurality of requests to hydrate the first prompt template, to determine the ranking strategy to associate with the first prompt template from among the set of new candidate ranking strategies.

14. The data processing system of claim 1, to hydrate the first prompt template based at least in part on the ranking strategy selected from among the set of candidate ranking strategies to rank the data in response to subsequent request, the memory further stores executable instructions that, when executed, cause the processor alone or in combination with other processors to perform operations of:
obtaining data associated with a user associated with a result to hydrate the first prompt template.

15. A method implemented in a data processing system for operating a prompt hydration framework, the method comprising:
receiving a first prompt template comprising a natural language prompt for a large language model that includes a placeholder term configured to be replaced with data when the first prompt template is hydrated to create an executable prompt, the placeholder term being associated with one or more first data sources that include data used to replace the placeholder term;
comparing features of the first prompt template with features of a plurality of second prompt templates of a prompt template dataset to identify a set of similar prompt templates from the plurality of second prompt templates that satisfy a similarity threshold, each respective prompt template of the plurality of second prompt templates being associated with a respective ranking strategy for ranking data obtained from one or more second data sources to hydrate the respective prompt template;
associating a set of candidate ranking strategies with the first prompt template, the set of candidate ranking strategies including a ranking strategy associated with prompt templates included in the set of similar prompt templates;
in response to a plurality of requests to hydrate the first prompt template, identify a ranking strategy from the set of candidate ranking strategies to associate with the first prompt template;
receiving user feedback received in response to hydrating the first prompt template using the set of candidate ranking strategies;
selecting a ranking strategy from among the set of candidate ranking strategies based on the user feedback; and
utilizing the ranking strategy selected from among the set of candidate ranking strategies to rank the data in response to subsequent requests to hydrate the first prompt template.

16. The method of claim 15, wherein testing the set of candidate ranking strategies further comprises:
selecting a respective ranking strategy from among the set of candidate ranking strategies in response to a respective request to hydrate the first prompt template;
obtaining data from the one or more first data sources in response to the respective request to hydrate the first prompt template;
ranking the data from the one or more first data sources according to the respective ranking strategy selected from among the set of candidate ranking strategies to generate ranked data;
hydrating the first prompt template by replacing the placeholder term in the first prompt template with data from the ranked data to generate a first hydrated prompt; and
providing the first hydrated prompt to an application to present on user interface of the application.

17. The method of claim 15, wherein comparing the features of the first prompt template with features of the plurality of second prompt templates to identify the set of similar prompt templates further comprises:
analyzing the first prompt template with an embeddings model to generate embeddings that provide a first numerical vector representation of features of the first prompt template;
analyzing the plurality of second prompt templates with the embeddings model to generate embeddings that provide second numerical vector representations of features of the plurality of second prompt templates; and
comparing the first numerical vector representation of the first prompt template with the second numerical vector representations of the plurality of second prompt templates to identify the set of similar prompt templates that satisfy the similarity threshold.

18. The method of claim 17, wherein comparing the first numerical vector representation of the first prompt template with the second numerical vector representations of the plurality of second prompt templates to identify the set of similar prompt templates that satisfy the similarity threshold further comprises:
selecting a predetermined number of the plurality of second prompt templates that are most similar to the first prompt template as the set of similar prompt templates.

19. A machine-readable medium on which are stored instructions that, when executed, cause a processor of alone or in combination with other processors to perform operations of:
receiving a first prompt template comprising a natural language prompt for a large language model that includes a placeholder term configured to be replaced with data when the first prompt template is hydrated to create an executable prompt, the placeholder term being associated with one or more first data sources that include data used to replace the placeholder term;
comparing features of the first prompt template with features of a plurality of second prompt templates of a prompt template dataset to identify a set of similar prompt templates from the plurality of second prompt templates that satisfy a similarity threshold, each respective prompt template of the plurality of second prompt templates being associated with a respective ranking strategy for ranking data obtained from one or more second data sources to hydrate the respective prompt template;
associating a set of candidate ranking strategies with the first prompt template, the set of candidate ranking strategies including a ranking strategy associated with prompt templates included in the set of similar prompt templates;
in response to a plurality of requests to hydrate the first prompt template, identify a ranking strategy from the set of candidate ranking strategies to associate with the first prompt template;
receiving user feedback received in response to hydrating the first prompt template using the set of candidate ranking strategies;
selecting a ranking strategy from among the set of candidate ranking strategies based on the user feedback; and
utilizing the ranking strategy selected from among the set of candidate ranking strategies to rank the data in response to subsequent requests to hydrate the first prompt template.

20. The machine-readable medium of claim 19, wherein to test the set of candidate ranking strategies the machine-readable medium further stores executable instructions that, when executed, cause the processor alone or in combination with other processors to perform operations of:
selecting a respective ranking strategy from among the set of candidate ranking strategies in response to a respective request to hydrate the first prompt template;
obtaining data from the one or more first data sources in response to the respective request to hydrate the first prompt template;
ranking the data from the one or more first data sources according to the respective ranking strategy selected from among the set of candidate ranking strategies to generate ranked data;
hydrating the first prompt template by replacing the placeholder term in the first prompt template with data from the ranked data to generate a first hydrated prompt; and
providing the first hydrated prompt to an application to present on user interface of the application.
